(19) United States
(12) Patent Application Publication
(10) Pub. No.: US 2025/0181707 A1
(43) Pub. Date: Jun. 5, 2025

(54) SYSTEM AND METHOD FOR TRAINING DEEP LEARNING NETWORKS RESISTANT TO ADVERSARIAL ATTACKS

(71) Applicant: ELECTRONICS AND TELECOMMUNICATIONS RESEARCH INSTITUTE, Daejeon (KR)

(72) Inventors: YuHyun SHIN, Daejeon (KR); Kimin YUN, Daejeon (KR); Yu Seok BAE, Daejeon (KR)

(73) Assignee: ELECTRONICS AND TELECOMMUNICATIONS RESEARCH INSTITUTE, Daejeon (KR)

(21) Appl. No.: 18/601,252

(22) Filed: Mar. 11, 2024

(30) Foreign Application Priority Data
Dec. 4, 2023 (KR) 10-2023-0172982

(51) Int. Cl. G06F 21/54; G06F 21/55; G06N 3/0895

(52) U.S. Cl. CPC G06F 21/54; G06F 21/55; G06N 3/0895; G06F 2221/033

(57) ABSTRACT

Disclosed herein is a method of training deep learning networks resistant to adversarial attacks, which includes inputting data into a pre-trained feature extractor to extract feature information, inputting the extracted feature information into a neural ordinary differential equation to output denoised feature information, and inputting the denoised feature information into a classifier to output estimated class information for the data.

### CROSS-REFERENCE TO RELATED APPLICATION

This application claims priority to and the benefit of Korean Patent Application No. 10-2023-0172982, filed on Dec. 4, 2023, the disclosure of which is incorporated herein by reference in its entirety.

### BACKGROUND

### 1. Technical Field

The present disclosure relates to a system and method for training deep learning networks to be resistant to adversarial attacks.

### 2. Related Arts

Adversarial attack is a form of attack against machine learning models, especially deep learning models. This attack aims to render model output incorrectly by making small changes to input data. These small changes are usually barely noticeable to humans, but they may significantly distort model outputs. For example, the adversarial attack applied to an image classification model may make the model classify an image, which could be easily classified as a “cat” by a person, as a “dog”.

This adversarial attack can be a major obstacle to ensuring that machine learning models operate safely and reliably in real-world applications. For example, an adversarial attack on an autonomous vehicle or a medical diagnostic system is highly likely to cause serious problems.

### SUMMARY

Various embodiments are directed to a system and method for training deep learning networks resistant to adversarial attacks, to provide a deep learning network that is robust to adversarial attacks by adding a neural ordinary differential equation module to an existing well-trained deep neural network.

The present disclosure is not limited to the objects mentioned above, and other objects of the present disclosure will be clearly understood by those skilled in the art from the following description.

In accordance with a first aspect of the present disclosure, there is provided a method of training deep learning networks resistant to adversarial attacks, which includes inputting data into a pre-trained feature extractor to extract feature information, inputting the extracted feature information into a neural ordinary differential equation to output denoised feature information, and inputting the denoised feature information into a classifier to output estimated class information for the data.

In accordance with a second aspect of the present disclosure, there is provided a system for training deep learning networks resistant to adversarial attacks, which includes a pre-trained feature extractor configured to receive data to extract feature information, a neural ordinary differential equation configured to receive the extracted feature information to output denoised feature information, and a classifier configured to receive the denoised feature information to output estimated class information for the data.

In accordance with a third aspect of the present disclosure, there is provided a system for training deep learning networks resistant to adversarial attacks, which includes a memory configured to store a deep learning network-based program for estimating class information about data, and a processor configured to, as executing the program, input the data into a pre-trained feature extractor to extract feature information, input the extracted feature information into a neural ordinary differential equation to output denoised feature information, and input the denoised feature information into a classifier to output the estimated class information for the data.

In accordance with another aspect of the present disclosure, there is provided a computer program combined with a computer as hardware to execute a method of training deep learning networks resistant to adversarial attacks, the computer program being stored in a computer-readable recording medium.

Other specific details of the present disclosure are included in the following detailed description and drawings.

An embodiment of the present disclosure described above relates to a technology that can defend against adversarial attacks, and uses an approach of utilizing an existing pre-trained model as it is while adding an “add-on layer” with additional small parameters to the model. This allows, since a model whose stability has been previously verified is utilized as it is in the embodiment of the present disclosure, an enhanced defense function against adversarial attacks to be added while maintaining the stability and reliability of the model. In addition, the add-on layer with fewer parameters has the advantage of strengthening defense against attacks without increasing model complexity.

According to the embodiment of the present disclosure, the effect of preventing serious degradation in performance of the model that occurs in the early stage of adversarial training can be expected by utilizing the parameters of the existing trained model as they are and additionally training only the neural ordinary differential equation (neural ODE) module. In other words, by preserving the existing model parameters to maintain the initial performance of the model, it is possible to improve robustness against adversarial examples without significantly deteriorating model accuracy in the early stage of adversarial training.

The present disclosure is not limited to the above effects, and other effects of the present disclosure will be clearly understood by those skilled in the technologies from the following description.

### BRIEF DESCRIPTION OF THE DRAWINGS

FIGS. 1A and 1B are diagrams for explaining an existing deep learning network and a neural ordinary differential equation.

FIG. 2 is a diagram for explaining input and output of the neural ordinary differential equation using trajectory information.

FIG. 3 is a diagram illustrating an example of implementation of the neural ordinary differential equation.

FIG. 4 is a diagram for explaining a structure and learning process of a general object recognizer.

FIG. 5 is a diagram for explaining errors that occur in the stage of inference due to adversarial attacks on the object recognizer.

FIG. 6 is a diagram for explaining a system for training deep learning networks according to an embodiment of the present disclosure.

FIG. 7 is a diagram for explaining a process in which a noise-free clean feature is modified through the neural ordinary differential equation.

FIG. 8 is a diagram illustrating a configuration of a system for training deep learning networks according to an embodiment of the present disclosure.

FIG. 9 is a flowchart illustrating a method of training deep learning networks according to an embodiment of the present disclosure.

FIG. 10 is a diagram for explaining an adversarial transfer attack created using a leaked model.

FIG. 11A is a graph illustrating clean sample performance in relation to VGG16BN model training epoch, and FIG. 11B is a graph illustrating pgd-10 sample performance.

FIG. 12A is a graph illustrating clean sample performance in relation to ResNet-18 model training epoch, and FIG. 12B is a graph illustrating pgd-10 sample performance.

### DETAILED DESCRIPTION

Advantages and features of the present disclosure and methods of achieving them will become apparent with reference to the embodiments described below in detail in conjunction with the accompanying drawings. The present disclosure may, however, be embodied in different forms, and should not be construed as being limited to the embodiments set forth herein. Rather, these embodiments are provided so that the disclosure will be thorough and complete, and will fully convey the scope of the present disclosure to those skilled in the art to which the present disclosure pertains. The present disclosure should be defined based on the entire content set forth in the appended claims.

The terms as used herein are for the purpose of describing the embodiments and are not intended to limit the disclosure. As used herein, the singular forms “a”, “an” and “the” are intended to include the plural forms as well, unless context clearly indicates otherwise. It will be understood that the terms “comprises/includes” and/or “comprising/including” when used in the specification, specify the presence of stated components, but do not preclude the presence or addition of one or more other components. Like reference numerals refer to like elements throughout the specification, and “and/or” includes each and all combinations of the mentioned components. Although the terms such as “first” and/or “second” are used to describe various components, these components are not limited by these terms, of course. These terms are used merely to distinguish the corresponding component from other component(s). Therefore, it is natural that the first component set forth herein may be a second component within the spirit of the present disclosure.

Unless defined otherwise, all terms (including technical and scientific terms) used herein may have the same meaning as commonly understood by those skilled in the art to which the present disclosure pertains. In addition, terms, such as those defined in commonly used dictionaries, will not be interpreted in an idealized or overly formal sense unless expressly so defined herein.

The present disclosure relates to a system and method for training deep learning networks to be resistant to adversarial attacks.

The present disclosure is involved in the field of deep learning-based machine learning, and provides a learning methodology for models trained through machine learning to respond to adversarial attacks. Adversarial attack is one of the attack techniques for machine learning and deep learning models, and aims to distort model prediction by slightly modifying input data, mainly in image classification or other machine learning tasks.

This may significantly distort model prediction by adding or modifying very small changes or noise. Particularly, in the field of image recognition, if a noise pattern that is not noticeable to humans is added to an input image, people may recognize that image as an identical object, whereas a deep learning network may misrecognize that image as a completely different object. The present disclosure proposes a method of training deep learning networks with robustness against adversarial attacks.

Hereinafter, the background of the present disclosure will be described in detail to aid the understanding of those skilled in the art.

There are various methods of defense against adversarial attacks, and in general, the following four methods may be used:
(1) Input Filtering: it may be subjected to a preprocessing process that detects and filters noise or small changes;
(2) Model Ensemble: it may combine multiple models to offset the weaknesses of each model;
(3) Adversarial Training: it may also include examples of adversarial attacks when training any model, making the model more robust in adversarial situations; and
(4) Normalization & Data Augmentation: it may apply various normalizations or modifications to any model and data to increase the generalization ability of the model.

An embodiment of the present disclosure is a method that is of type (3), which utilizes and learns a new type of layer called an ordinary differential equation (ODE) layer in a deep learning network model prior to training techniques. A neural ordinary differential equation is a relatively new concept that combines ordinary differential equations and deep learning. A typical neural network operates by stacking multiple layers to approximate complex functions. These layers form a kind of “step”, and data is converted at every step.

However, the neural ordinary differential equation renders this concept of “step” more flexible. Here, ordinary differential equations are used to model continuous changes to allow data to be converted “smoothly”, which allows the model to autonomously adjust complexity as needed.

For example, 10 layers may be used to classify an image in a typical neural network, but these 10 layers may be viewed as a single “continuous process” in a neural ordinary differential equation. This continuous process is defined through general differential equations, the solutions of which are actually linked to any desired output (e.g., classification of images).

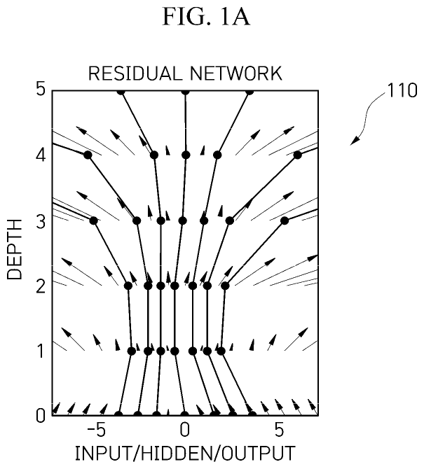

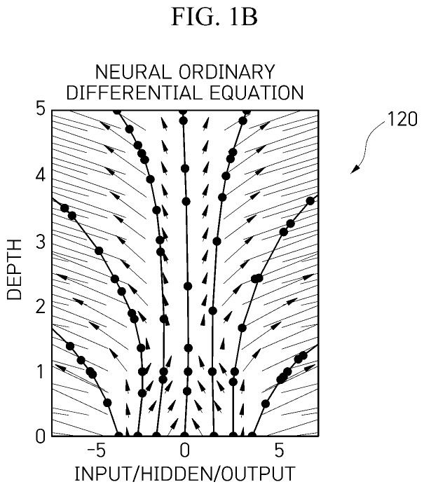

FIGS. 1A and 1B are diagrams for explaining an existing deep learning network and a neural ordinary differential equation.

As illustrated in FIG. 1A, if the output of the existing deep learning residual network 110 is obtained as a discrete value for each depth, the neural ordinary differential equation 120 illustrated in FIG. 1B has individual depths, but models values continuously during modeling, so that the training values of the deep learning network are modeled as continuous values.

This approach can not only increase model efficiency and solve complex problems with fewer parameters, but can also be very useful for special types of problems, such as processing continuous data over time.

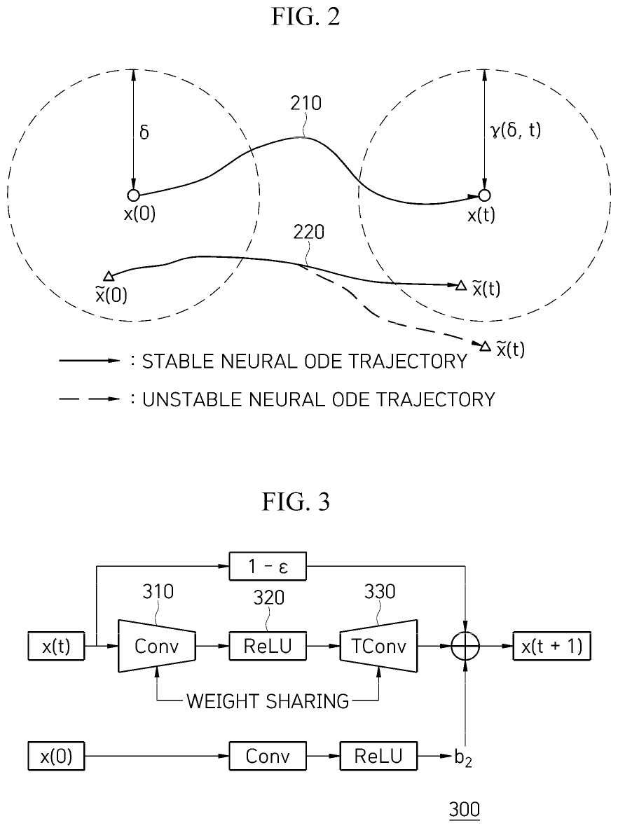

FIG. 2 is a diagram for explaining input and output of the neural ordinary differential equation using trajectory information.

The main idea of the embodiment of the present disclosure is to solve the problem of “Significant output distortion given small but adversarial input noise”, which is treated as a major problem by adversarial attacks based on the continuous characteristics of neural ordinary differential equations, namely, the characteristics of “smooth data transform”. Accordingly, the approach may be explained with reference to the stable neural ODE trajectory in FIG. 2. When input data x(0) generates output x(t) (210), other data \tilde{x}(0) located close to x(0) must ensure that output \tilde{x}(t) is also within a certain range of x(t) (220).

In order to realize these characteristics, the embodiment of the present disclosure analyzes an existing neural ordinary differential equation with the structure illustrated in FIG. 3. FIG. 3 is a diagram illustrating an example of implementation of the neural ordinary differential equation.

The structure illustrated in FIG. 3 is similar to the operation of a recurrent neural network (RNN). Here, it has a continuous structure in which the input of x(t) generates the output of x(t+1) at the next point in time. The key to this approach is to prove that the output x(t) of the ordinary differential equation layer does not amplify noise over time even if noise is added to the input.

However, previous research and inventions focused on enabling adversarial attacks by simply utilizing and training the neural ordinary differential equation itself.

In contrast, the proposed embodiment of the present disclosure focuses on utilizing the addition of the neural ordinary differential equation to the already verified and well-trained deep learning model. In other words, rather than introducing a neural ordinary differential equation layer to retrain an entire model from scratch, by adding a neural ordinary differential equation layer after an existing well-learned feature extractor and learning the neural ordinary differential equation using the distortion loss function proposed in the present disclosure, so that the entire model generate outputs robust to slight changes in the input.

Meanwhile, deep learning models utilize various normalization techniques to achieve optimal performance during learning. However, when the neural ordinary differential equation is introduced, some of the traditional normalization techniques do not work properly, which may significantly degrade model performance.

To solve this issue, the embodiment of the present disclosure proposes channel gain normalization, which is a new method of normalization, to effectively introduce a neural ordinary differential equation into an existing trained model.

Finally, the embodiment of the present disclosure defines the distance between features by utilizing a tighter boundary compared to the existing neural ordinary differential equation model. This proved that the change in output due to noise added to the input is limited within this boundary. This result plays an important role in proving the practical effectiveness of the present disclosure, which is revealed more clearly through the mathematical background.

In summary, the main purpose of the embodiment of the present disclosure is to address the vulnerability of deep learning networks to adversarial attacks. To this end, the embodiment of the present disclosure presents the following technical challenges and provides solutions thereto.

First, the large changes in values that occur due to the structural characteristics of traditional multilayer neural networks and the resulting vulnerability to adversarial attacks are solved through the introduction of neural ordinary differential equation layers. The continuous value modeling characteristics of neural ordinary differential equations are utilized to limit the change in output due to subtle changes in input within a specific boundary.

In addition, the embodiment of the present disclosure can maximize network utilization by adding a neural ordinary differential equation layer to an already well-trained network without the need to retrain the existing deep neural network from scratch in the process of establishing defense mechanism against adversarial attacks.

Furthermore, in order to recognize the problems of existing normalization techniques due to the introduction of neural ordinary differential equation layers and solve these problems, the embodiment of the present disclosure proposes a channel gain normalization technique. Moreover, a distortion loss function is introduced to minimize damage to features that may occur from adversarial attacks.

By applying these techniques, the embodiment of the present disclosure can be expected to improve robustness against adversarial attacks while protecting existing deep learning models. In this way, the embodiment of the present disclosure is expected to make a significant contribution to use in applications with high safety requirements, such as autonomous vehicles.

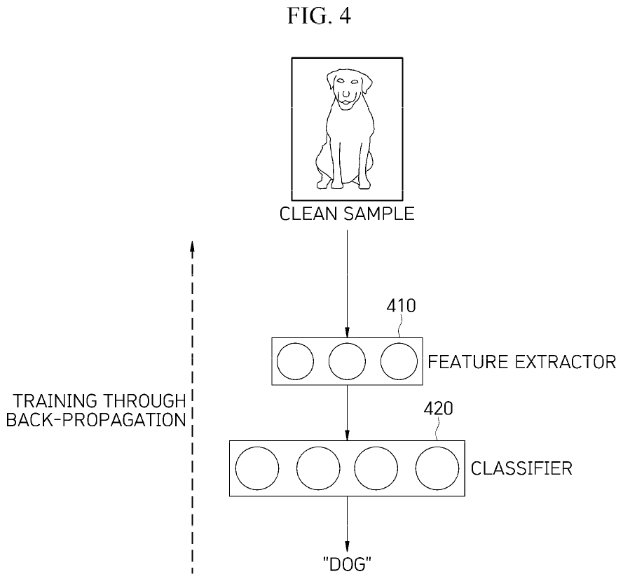

Hereinafter, a system and method for training deep learning networks to be resistant to adversarial attacks according to embodiments of the present disclosure will be described in detail with reference to FIGS. 4 to 7.

FIG. 4 is a diagram for explaining a structure and learning process of a general object recognizer.

Prior to description of the present disclosure, an example of training of general deep neural networks for object recognition will be described with reference to FIG. 4. To train a neural network for object recognition, a class name paired with an image is given. The neural network has parameters continuously adjusted. When an image is input into the neural network, the neural network is trained so that the class corresponding to the input is estimated as a result. It is mainly composed of a feature extractor 410 that extracts the characteristics of the image and a classifier 420 that utilizes the same. Although a single layer is illustrated for simplicity in FIG. 4, it may be composed of multiple layers in a complex network structure in reality.

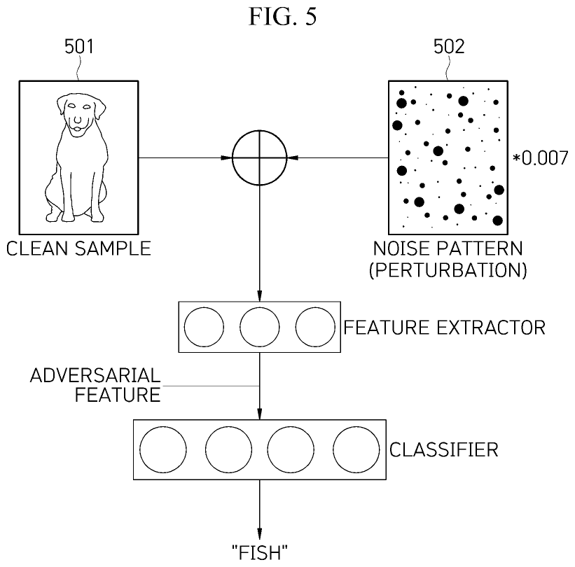

FIG. 5 is a diagram for explaining errors that occur in the stage of inference due to adversarial attacks on the object recognizer.

This traditional model can be very sensitive to external noise. In other words, the traditional model can output strange results even though a very small noise pattern is added to the input data. FIG. 5 illustrates that the recognizer shows an error in the stage of inference due to adversarial attacks. When a visually meaningless noise value 501 is multiplied by a very small value of 0.007 and the resultant value is added to a noise-free clean sample 502, even if no significant distortion is applied to the image, the result of having passed through the feature extractor 510 and the classifier 520 may be output as “FISH” that has no relation to “DOG” at all.

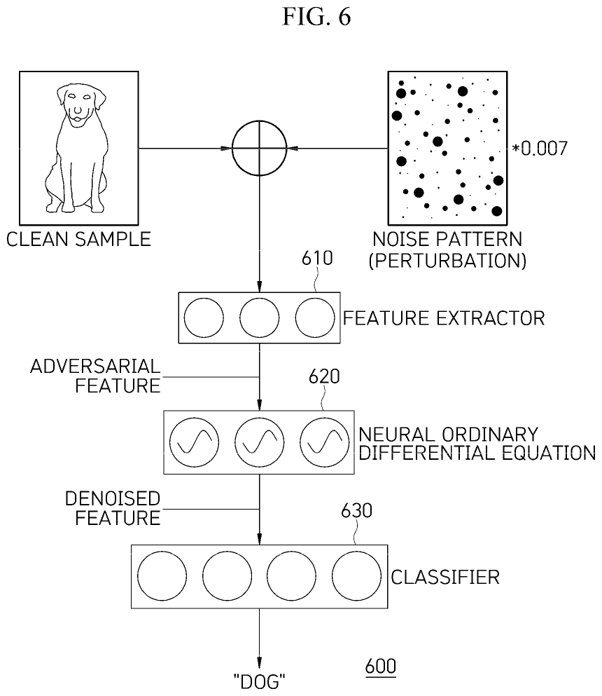

FIG. 6 is a diagram for explaining a system for training deep learning networks according to an embodiment of the present disclosure.

The system for training deep learning networks, which is designated by reference numeral 600, according to the embodiment of the present disclosure includes a feature extractor 610, a neural ordinary differential equation 620, and a classifier 630.

The feature extractor 610 receives input data and extracts feature information.

The neural ordinary differential equation 620 receives the extracted feature information and outputs denoised feature information.

The classifier 630 receives the denoised feature information and outputs estimated class information for the input data.

In this case, the embodiment of the present disclosure is characterized in that the neural ordinary differential equation 620 is added between the feature extractor 610 and the classifier 630 which are existing deep learning networks. This can resolve the problems that have occurred in the classifier 630 due to adversarial features, and allows the denoised feature information to be output to form a deep learning network resistant to adversarial attacks.

In particular, the weight of the model that have already been trained in large capacity is used as it is, and only the neural ordinary differential equation 620 is added to additionally learn only a small number of parameters corresponding thereto. As a result, it is possible to utilize the neural network trained in various existing applications as it is, and at the same time, to improve robustness against adversarial attacks.

However, if a method is taken of simply adding and training only a neural ordinary differential equation in an embodiment of the present disclosure, the regularization technique that has been efficiently utilized for training of various existing neural networks may not be applicable in some cases. Generally, in the stage of inference of the neural network, it is multiplied by the weight in the layer and then advances to the next layer. If this weight is too large or small, the change in output will also be significant, so the learning is usually performed in company with normalization of the weight. However, simply normalizing the weight of the neural ordinary differential equation proposed in the embodiment of the present disclosure may not sometimes achieve an intended effect, and the reasons are as follows.

Referring to the neural ordinary differential equation in FIG. 3, it can be seen that, in the configuration of the neural ordinary differential equation, the weight is subjected to convolution 310, ReLU 320, and then transposed convolution (TCONV) 330. In other words, in order to go from x(t) to x(t+1), it needs to be normalized in the form of multiplication of W^{T}W like W^{T}σ(Wx(t)+b), but simply normalizing the weight like existing neural networks causes issues.

To solve these issues, the embodiment of the present disclosure uses a channel gain normalization technique.

In other words, weight normalization may be performed on the weights of the convolution and transposed convolution that make up the neural ordinary differential equation by using the channel gain of the neural ordinary differential equation. The channel gains that may be learned from the output of the weighted-normalized neural ordinary differential equation are then multiplied again for each channel of the neural ordinary differential equation.

Specifically, the channel gain normalization may be performed based on the following Equation 1. Similar to the existing weight normalization method,

$$W = GV = \frac{1}{\sqrt{c}} V$$

is obtained by dividing a convolution matrix W into a convolution weight matrix G and a convolution direction matrix V and replacing the convolution matrix G within the neural ordinary differential equation by the inverse product of the square root value of the number of channels c. Once the solution x(T) of the ordinary differential equation is then calculated, the final output of the neural ordinary differential equation is calculated by additionally multiplying the solution x(T) of the ordinary differential equation by the gain matrix

$$[ \begin{matrix}{g}_{1} I & ⋯ & O \\ ⋮ & ⋱ & ⋮ \\ O & ⋯ & {g}_{c} I\end{matrix} ] .$$

This may be expressed in the following Equation.

$$Channel Gain Normalization : W = GV = \frac{1}{\sqrt{c}} V = \frac{1}{\sqrt{c}} [ \begin{matrix}{V}_{11} & ⋯ & {V}_{c 1} \\ ⋮ & ⋱ & ⋮ \\ {V}_{1 c} & ⋯ & {V}_{cc}\end{matrix} ] {W}^{T} W , with \qquad [ Equation 1 ]$$

$${W}^{T} W = \frac{1}{c} {V}^{T} V = \frac{1}{c} [ \begin{matrix}{\sum }_{k = 1}^{c} {V}_{1 k}^{T} {V}_{k 1} & ⋯ & {\sum }_{k = 1}^{c} {V}_{1 k}^{T} {V}_{k c} \\ ⋮ & ⋱ & ⋮ \\ {\sum }_{k = 1}^{c} {V}_{ck}^{T} {V}_{k 1} & ⋯ & {\sum }_{k = 1}^{c} {V}_{ck}^{T} {V}_{k c}\end{matrix} ]$$

$$Channel gains are applied to ode solution x ( T ) , i . e . ,$$

$$x ( T ) = x ( 0 ) + {\int }_{t = 0}^{T} [ - {W}^{T} σ ( Wx ( t ) + {b}_{1} ) - ε I \cdot x ( t ) + {b}_{2} ] dt ,$$

$$and the output of ODE module is given by : [ \begin{matrix}{g}_{1} I & ⋯ & O \\ ⋮ & ⋱ & ⋮ \\ O & ⋯ & {g}_{c} I\end{matrix} ] \cdot x ( T )$$

Meanwhile, the previous research has proven that x(0) to x(t) obtained by passing through the neural ordinary differential equation as illustrated in FIG. 2 exist within a specific boundary, and the embodiment of the present disclosure checks that it is more robust against adversarial attacks compared to the prior art by adding two more characteristics.

Firstly, it can be seen that the distance between the output values of the activation function is maintained within a certain level by using the weight W of the neural ordinary differential equation layer. In the case where there is a clean sample and a noise sample, it can be seen below that, if a time t is large enough in the space that has passed through the neural ordinary differential equation layer, it is within a specific boundary.

In other words, assuming that the clean sample x(0) and the noisy sample \tilde{x}(0) are input into the neural ordinary differential equation and the trajectories starting from x(0) and \tilde{x}(0) are x(t) and \tilde{x}(t), respectively, it can be seen that, if t is sufficiently large, the output value is limited to a specific boundary as shown in the following Equation:

$$‖ σ ( Wx ( t ) ) - σ ( W \tilde{x} ( t ) ) ‖ \leq \frac{L}{2 \sqrt{ε}} \cdot ‖ x ( 0 ) - \tilde{x} ( 0 ) ‖ \qquad [ Equation 2 ]$$

where L is a Lipschitz constant of b₂, a function whose value is determined by the initial value of the neural ordinary differential equation, and ε is a constant value greater than 0 that determines the strength of the damping term of the ordinary differential equation.

Secondly, the embodiment of the present disclosure can further reduce the boundary for noise in the neural ordinary differential equation by setting the convolution matrix for the neural ordinary differential equation to be non-singular and applying a Leaky ReLU-based activation function to the neural ordinary differential equation.

In other words, in the existing neural ordinary differential equation, the boundary between x(t) and x(0) falls within a fairly wide boundary area. On the other hand, in the proposed embodiment of the present disclosure, the convolution matrix W is non-singular and Leaky ReLU is used as an activation function.

Accordingly, the boundary of input/output noise at a specific time t was

$$\frac{L}{ϵ}$$

in the prior art, but it can be seen that the boundary falls within reduced

$$min \{ \frac{L}{ε + {αλ}_{min}^{2}} , \frac{L}{ε} \frac{ε + α ( {λ}_{max}^{2} - {ελ}_{min}^{2} )}{ε + {αλ}_{max}^{2}} \}$$

in the embodiment of the present disclosure. This allows the present disclosure to improve and design the existing neural ordinary differential equation to enable defense against more powerful adversarial attacks.

Here, λₘᵢₙ² and λₘₐₓ² are the squares of the minimum/maximum singular value of the convolution matrix W, and a is a slope value of the negative domain of the Leaky ReLU function.

In order to solve the distortion caused by the specificity of using a pre-trained model, the embodiment of the present disclosure is characterized by simultaneously improving adversarial attack performance and clean sample performance through learning using a distortion loss function.

In general, when an artificial neural network is trained by an adversarial training method, all parameter values of the artificial neural network change, and the rate of recognition success for clean sample images without adversarial noise inserted decreases.

However, since the system for training deep learning networks according to the embodiment of the present disclosure performs operations on pre-learned feature information through a neural ordinary differential equation, there is also a possibility that clean features are modified through the neural ordinary differential equation.

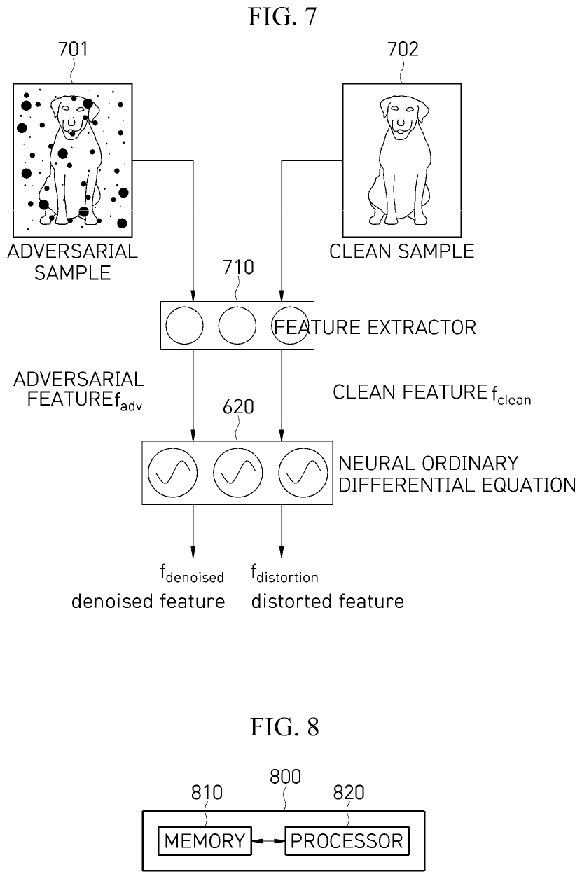

FIG. 7 is a diagram for explaining a process in which a noise-free clean feature is modified through the neural ordinary differential equation.

In order to prevent the modification of the clean feature and ensure that the denoised feature has a similar form to the clean feature, the distortion loss function is defined as follows.

$${ℒ}_{distortion} = ‖ {f}_{clean} - {f}_{adv} ‖ + ‖ {f}_{clean} - {f}_{distortion} ‖ \qquad [ Equation 3 ]$$

First, to obtain the distortion loss function, first distance information ∥f_{clean}−f_{adv}∥ between clean feature information f_{clean} and adversarial feature information f_{adv} is calculated. In this case, the clean feature information and the adversarial feature information may be obtained from the output as a clean sample 702 and an adversarial sample 701 are input into a feature extractor 710.

Second distance information between clean feature information f_{clean} and distorted feature information f_{distortion} is then calculated. Here, the distorted feature information may be obtained from the output as the clean feature information is input into a neural ordinary differential equation 720. The first and second distance information may use any L-p norm, and it is experimentally seen that good performance is exhibited just by using L-1 norm.

The distortion loss function [symbol] _{distortion} may be obtained by adding the first and second distance information calculated in this way, and the neural ordinary differential equation 720 may be trained based on the distortion loss function.

In addition, the embodiment of the present disclosure may train the neural ordinary differential equation 720 by reflecting the distortion loss function [symbol] _{distortion} to any other objective function [symbol] _{obj} and calculating a final loss function as shown in the following Equation.

$$ℒ = {ℒ}_{obj} + λ \cdot {ℒ}_{distortion} \qquad [ Equation 4 ]$$

In the embodiment of the present disclosure, when learning is performed using the final loss function, it is possible to prevent overfitting in the neural ordinary differential equation 720 and achieve better performance under certain conditions.

FIG. 8 is a diagram illustrating a configuration of a system for training deep learning networks 800 according to an embodiment of the present disclosure.

The system for training deep learning networks 800 according to the embodiment of the present disclosure includes a memory 810 and a processor 820.

The memory 810 stores a deep learning network-based program for estimating class information about data. Here, the memory 810 is a general term for non-volatile storage devices and volatile storage devices that continue to retain stored information even when power is not supplied thereto. For example, the memory 810 may include a NAND memory such as a compact flash (CF) card, a secure digital (SD) card, a memory stick, a solid state drive (SSD), or a micro SD card, a magnetic computer storage device such as a hard disk drive (HDD), and an optical disc drive such as CD-ROM or DVD-ROM, and so on.

The processor 820 may control at least one other component (e.g., hardware or software component) of the deep learning network device 100 by executing software such as a program, and may perform various data processing or operations.

The processor 820, as executing the program, inputs data into a pre-trained feature extractor to extract feature information, inputs the extracted feature information into a neural ordinary differential equation to output denoised feature information, and inputs the denoised feature information into a classifier to output estimated class information for the data.

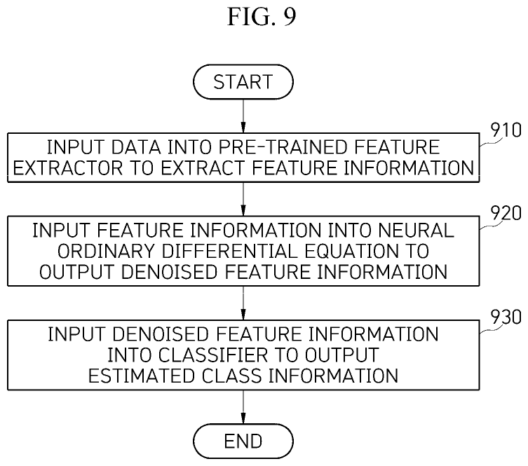

FIG. 9 is a flowchart illustrating a method of training deep learning networks according to an embodiment of the present disclosure.

In the embodiment of the present disclosure, data is first input into a pre-trained feature extractor to extract feature information (S910).

Next, the extracted feature information is input into a neural ordinary differential equation to output denoised feature information (S920).

Next, the denoised feature information is input into a classifier to output estimated class information for the data (S930).

Meanwhile, in the above description, steps S910 to S930 may be further divided into additional steps or combined into fewer steps, depending on the implementation of the present disclosure. Additionally, if necessary, some steps may be omitted or the order between steps may be changed. In addition, the contents of FIGS. 4 to 7 and the contents of FIGS. 8 and 9 may be mutually applied.

Hereinafter, the test results of effectiveness of the present disclosure will be described in detail.

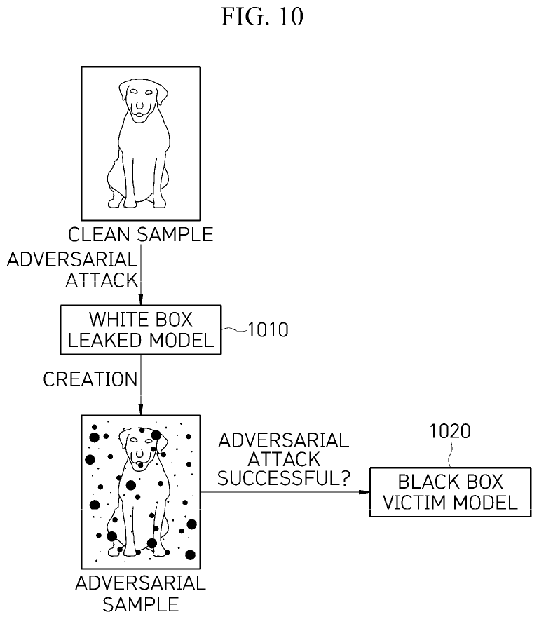

FIG. 10 is a diagram for explaining a situation in which access to an updated model is impossible.

The adversarial attack is divided into a white-box attack 1010 and a black-box attack 1020. The white-box attack 1010 is an attack carried out by an attacker that knows all the parameters and mechanisms of a model. Although it is very powerful, the white-box attack is a realistically difficult attack considering that real-world artificial intelligence service models are not public. Thus, the present disclosure assumes a situation similar to the situation of the black-box attack 1020 in which the attacker does not accurately know the parameters of the model. To be precise, this is a situation assumed that, when any artificial intelligence model is leaked to the outside due to a security incident such as hacking or insider leakage, the attacker can access the leaked model, but cannot access the updated model, ODE add-on, or the like. This situation is illustrated in FIG. 10.

In the case where any model is leaked, a situation is assumed that the attacker executes an attack on the black-box victim model 1020 (which may have been updated through adversarial training, etc.) using the adversarial sample created based on the leaked model.

Both conventional adversarial training and neural ordinary differential equation training are performed using the adversarial sample created based on the leaked model. A fast gradient sign method (FGSM) is used to create the adversarial sample. The adversarial training is divided into two cases: adversarial training in which the leaked model is trained using initial learning rate=0.1 and adversarial fine-tuning in which the leaked model is trained using initial learning rate=0.01.

The neural ordinary differential equation training is divided into three cases. For the neural ordinary differential equation, a neural ordinary differential equation module is inserted after the first block of ResNet-18 and VGG-16-BN. Here, the neural ordinary differential equation module is composed of two neural ordinary differential equation layers followed by a ReLU layer. In the process of training, the adversarial training is performed only on the add-on ODE module and the parameters of the pre-trained model are fixed. The ODE+distortion loss function is similar to ODE, but uses the distortion loss function as a learning loss function. In this case, the hyper parameter λ value was 0.01 for the ResNet-18 model and 0.05 for the VGG-16-BN model.

The following Table 1 shows the results of experiment conducted under the assumption that an image recognition model with ResNet-18 structure is leaked, and shows the performance comparison results of adversarial training and ODE training when the ResNet-18 model is leaked. The following Table 2 shows the results of experiment conducted under the assumption that an image recognition model with VGG-16-BN structure is leaked, and shows the performance comparison results of adversarial training and ODE training when the VGG-16-BN model is leaked. In both cases, the experiments were conducted in the environment of CIFAR-10 dataset.

TABLE 1

| | Adversarial | Adversarial | | ODE with |
|---|---|---|---|---|
| ResNet-18 | Training | Fine-Tuning | | Distortion |
| (CIFAR-10) | (Lr = 0.1) | (Lr = 0.01) | ODE | Loss |
| MIFGSM | 0.7378 | 0.7609 | 0.8367 | 0.8555 |
| TIFGSM | 0.7245 | 0.7493 | 0.725 | 0.6910 |
| DIFGSM | 0.7274 | 0.7508 | 0.8144 | 0.8278 |
| VNIFGSM | 0.7186 | 0.7473 | 0.8115 | 0.8511 |
| VMIFGSM | 0.7236 | 0.7514 | 0.8153 | 0.8547 |
| NIFGSM | 0.7364 | 0.7608 | 0.8195 | 0.8428 |
| SINIFGSM | 0.7268 | 0.7549 | 0.8124 | 0.8308 |
| clean | 0.7632 | 0.7822 | 0.8221 | 0.8084 |

TABLE 2

| | Adversarial | Adversarial | | ODE with |
|---|---|---|---|---|
| VGG-16-BN | Training | Fine-Tuning | | Distortion |
| (CIFAR-10) | (Lr = 0.1) | (Lr = 0.01) | ODE | Loss |
| MIFGSM | 0.7521 | 0.7670 | 0.8066 | 0.8228 |
| TIFGSM | 0.7811 | 0.7973 | 0.6999 | 0.7351 |
| DIFGSM | 0.7382 | 0.7521 | 0.782 | 0.8016 |
| VNIFGSM | 0.7109 | 0.7271 | 0.7621 | 0.7896 |
| VMIFGSM | 0.7199 | 0.7395 | 0.7740 | 0.7985 |
| NIFGSM | 0.7543 | 0.7729 | 0.8036 | 0.8150 |
| SINIFGSM | 0.7434 | 0.7631 | 0.8043 | 0.8077 |
| clean | 0.8256 | 0.8457 | 0.8426 | 0.8412 |

Experimentally, it was seen that the ODE add-on learning module exhibits better performance against all transfer attacks except for the TIFGSM attack. However, since the TIFGSM attack is an attack that is based on the translated image but is basically designed for use on the ImageNet dataset, it has default translation settings that are too large to be applied to CIFAR-10 data. Hence, the basic premise of the adversarial attack, imperceptibility, may be broken in the CIFAR-10 dataset.

Therefore, in order to solve the issue, the performance when the translation scale is adjusted to fit CIFAR-10 data is shown in the following Table 3 and Table 4, and it can be seen that the performance gap is greatly reduced. Table 3 shows the results of experiment on ResNet-18 model adversarial training and ODE training of TIFGSM with translation scale adjusted, and Table 4 shows the results of experiment on VGG-16-BN model adversarial training and ODE training of TIFGSM with translation scale adjusted.

TABLE 3

| | Adversarial | Adversarial | | ODE + |
|---|---|---|---|---|
| ResNet-18 | Training | Fine-Tuning | | Distortion |
| (CIFAR-10) | (Lr = 0.1) | (Lr = 0.01) | ODE | Loss |
| TIFGSM | 0.7241 | 0.7468 | 0.7261 | 0.6898 |
| (nsig = 1) | | | | |

TABLE 4

| | Adversarial | Adversarial | | ODE + |
|---|---|---|---|---|
| VGG-16-BN | Training | Fine-Tuning | | Distortion |
| (CIFAR-10) | (Lr = 0.1) | (Lr = 0.01) | ODE | Loss |
| TIFGSM | 0.7817 | 0.7963 | 0.7662 | 0.7804 |
| (nsig = 1) | | | | |

In the embodiment of the present disclosure, since the parameters of the existing learning model are utilized without changing, the temporary degradation in performance due to adversarial training is very small compared to existing adversarial training even in the early stage of learning.

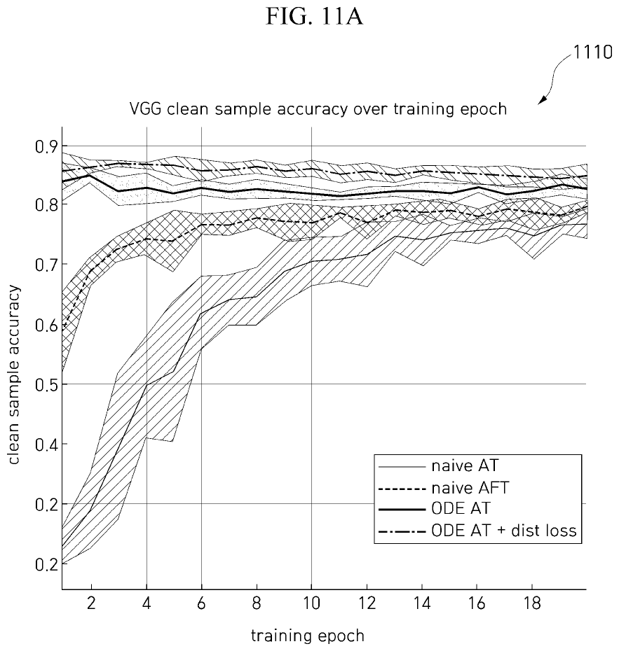

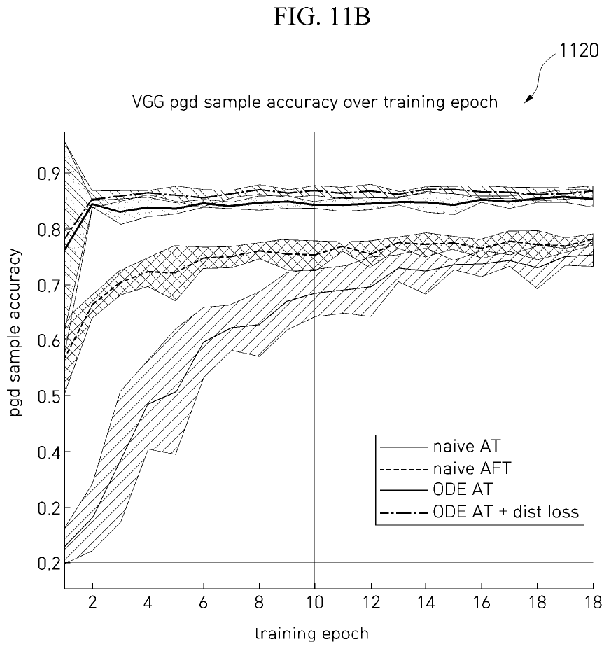

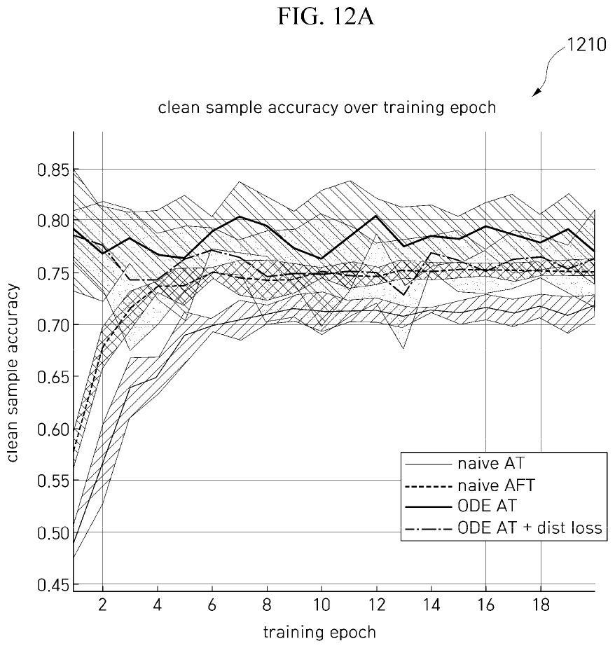

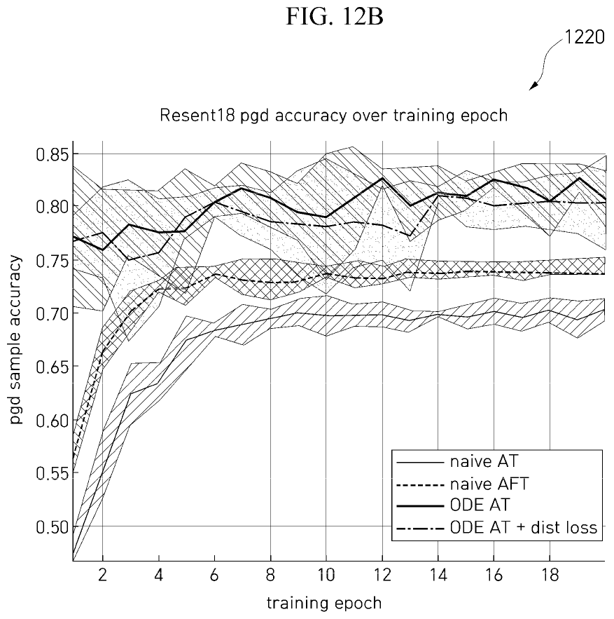

FIG. 11A is a graph illustrating clean sample performance in relation to VGG16BN model training epoch (1110), and FIG. 11B is a graph illustrating pgd-10 sample performance (1120). FIG. 12A is a graph illustrating clean sample performance in relation to ResNet-18 model training epoch (1210), and FIG. 12B is a graph illustrating pgd-10 sample performance (1220). In FIGS. 11A to 12B, the training was performed using the CIFAR-10 dataset.

FIGS. 11A to 12B illustrate the accuracy of the pgd-10 sample created based on the clean sample and leaked model in relation to the training epoch up to training epoch 20 of the VGG16BN structure model and the ResNet-18 structure model, respectively. Compared to general adversarial training (AT) or adversarial fine-tuning (AFT) that sets a small initial learning rate, it can be seen that ODE training (green graph) and ODE training using distortion loss (red graph) are higher in performance from training epoch 1 than the existing method. Therefore, the ODE training may be used to quickly update model security when quick model update is required due to leakage of the existing learning model.

By using the system and method for training deep learning networks to be resistant to adversarial attacks according to embodiments of the present disclosure, it is possible to improve the robustness of security-critical vision applications such as autonomous vehicles and medical AI.

In particular, the training of the proposed neural ordinary differential equation can be freely added to the already existing vision system, and can simultaneously improve the accuracy of clean samples and the accuracy of adversarial samples compared to the existing adversarial training because it uses the feature information of the pre-trained model. Therefore, by additionally applying the training of the neural ordinary differential equation to security-critical applications such as image recognition systems for autonomous vehicles and medical AI, it is possible to improve performance against malicious noise injection attacks compared to the existing adversarial training without significantly reducing performance on clean samples.

The embodiments of the present disclosure described above may be implemented as a program (or application) and stored in a medium for execution in combination with a computer that is hardware.

The above program may include a code written in a computer language, such as C, C++, JAVA, Ruby, or machine language, which can be read through the device interface of the computer by the processor (CPU) of the computer, for execution of the methods implemented as the program read by the computer. Such a code may include a functional code related to a function or the like that defines necessary functions for executing the methods, and may include an execution procedure-related control code necessary for the processor of the computer to execute the functions in accordance with predetermined procedures. In addition, the code may further include a memory reference-related code indicating that the additional information or media required for the processor of the computer to execute the above functions should be referenced at which location (address number) in the internal or external memory of the computer. Moreover, if the processor of the computer needs to communicate with any other remote computer or server to execute the above functions, the code may further a communication-related code indicative of how to communicate with any other remote computer or server using the communication module of the computer, what information or media should be transmitted and received during communication, or the like.

The storage medium refers to any medium that stores data semi-permanently and is readable by a device, rather than a medium that stores data for a short moment, such as a register, a cache, or a memory. Specifically, examples of the storage medium include, but are not limited to, ROM, RAM, CD-ROM, magnetic tape, floppy disk, and optical data storage device. That is, the program may be stored in various recording media on various servers that are accessible by the computer or in various recording media on the computer of the user. Moreover, the medium may be distributed over a networked computer system, and may store a computer-readable code in a distributed scheme.

The above embodiments of the present disclosure are merely examples, and it will be understood by those skilled in the art to which the present disclosure pertains that various modifications may be made without departing from the spirit and scope or essential features of the disclosure. Therefore, it should be understood that the embodiments described above are for purposes of illustration only in all aspects and are not intended to limit the scope of the present disclosure. For example, each component described in a single form may be implemented in a distributed form, and similarly, components described in the distributed form may be implemented in a combined form.

The scope of the present disclosure is defined by the appended claims, and it should be construed that all modifications or variations derived from the meaning, scope, and equivalent concept of the claims fall within the scope of the disclosure.

What is claimed is:

1. A method of training deep learning networks resistant to adversarial attacks, comprising:
inputting data into a pre-trained feature extractor to extract feature information;
inputting the extracted feature information into a neural ordinary differential equation to output denoised feature information; and
inputting the denoised feature information into a classifier to output estimated class information for the data.

2. The method according to claim 1, further comprising:
performing weight normalization on weights of convolution and transposed convolution that make up the neural ordinary differential equation by using a channel gain of the neural ordinary differential equation; and
applying the channel gain learnable from the output of differential the weighted-normalized neural ordinary equation for each channel of the neural ordinary differential equation.

3. The method according to claim 1, wherein the inputting the extracted feature information into a neural ordinary differential equation to output denoised feature information comprises:
setting a convolution matrix for the neural ordinary differential equation to be non-singular; and
applying a Leaky ReLU-based activation function to the neural ordinary differential equation to reduce a boundary for noise.

4. The method according to claim 1, further comprising:
inputting sample data corresponding to an adversarial attack into the feature extractor to extract adversarial feature information;
calculating first distance information between the feature information and the adversarial feature information;
calculating second distance information between the feature information and distorted feature information;
adding the first and second distance information to obtain a distortion loss function; and
training the neural ordinary differential equation based on the distortion loss function.

5. The method according to claim 4, wherein, in the training the neural ordinary differential equation based on the distortion loss function, the neural ordinary differential equation is trained based on a final loss function obtained by reflecting the distortion loss function to an objective function.

6. A system for training deep learning networks resistant to adversarial attacks, comprising:
a pre-trained feature extractor configured to receive data to extract feature information;
a neural ordinary differential equation configured to receive the extracted feature information to output denoised feature information; and
a classifier configured to receive the denoised feature information to output estimated class information for the data.

7. The system according to claim 6, wherein the neural ordinary differential equation is configured to perform weight normalization on weights of convolution and transposed convolution that make up the neural ordinary differential equation by using a channel gain of the neural ordinary differential equation, and the channel gain learnable from the output of the weighted-normalized neural ordinary differential equation is applied for each channel of the neural ordinary differential equation.

8. The system according to claim 6, wherein the neural ordinary differential equation sets a convolution matrix to be non-singular, and applies a Leaky ReLU-based activation function to reduce a boundary for noise.

9. The system according to claim 6, wherein the neural ordinary differential equation is trained based on a distortion loss function obtained by adding first distance information between the feature information and adversarial feature information output as sample data corresponding to an adversarial attack is input into the feature extractor and second distance information between the feature information and distorted feature information due to distortion occurring in output corresponding to the feature information input to the neural ordinary differential equation.

10. The system according to claim 9, wherein the neural ordinary differential equation is trained based on a final loss function obtained by reflecting the distortion loss function to an objective function.

11. A system for training deep learning networks resistant to adversarial attacks, comprising:
a memory configured to store a deep learning network-based program for estimating class information about data; and
a processor configured to, as executing the program, input the data into a pre-trained feature extractor to extract feature information, input the extracted feature information into a neural ordinary differential equation to output denoised feature information, and input the denoised feature information into a classifier to output the estimated class information for the data.
